(19) United States
(12) Patent Application Publication
(10) Pub. No.: US 2020/0201838 A1
(43) Pub. Date: Jun. 25, 2020

(54) MIDDLEWARE TO AUTOMATICALLY VERIFY SMART CONTRACTS ON BLOCKCHAINS

(71) Applicant: SRI International, Menlo Park, CA (US)

(72) Inventors: Gabriela Ciocarlie, New York, NY (US); Karim Eldefrawy, Palo Alto, CA (US); Tancrede Lepoint, Jersey City, NJ (US); Jorge Navas Laserna, Sunnyvale, CA (US); Akos Hajdu, Eger (HU); Dejan Jovanovic, Brooklyn, NY (US)

(21) Appl. No.: 16/227,728

(22) Filed: Dec. 20, 2018

(51) Int. Cl. G06F 16/23; H04L 9/06

(52) U.S. Cl. CPC G06F 16/2365; H04L 2209/38; H04L 9/0637; G06F 16/2379

(57) ABSTRACT

A method, apparatus and system for automated verification of a smart contract on a blockchain include translating operating properties of a smart contract annotated with contract specifications at a source code level into verification conditions in an intermediate verification language, discharging the verification conditions using an SMT solver, and reporting results of the discharged verification conditions, such as successes and failures of the discharged verification conditions. The translating can include mapping statements of the smart contract to statements of the intermediate verification language and mapping expressions of the smart contract to expressions of the intermediate verification language.

### FIELD

Embodiments of the present principles generally relate to smart contracts on blockchains and more specifically to methods, apparatuses and systems for verifying smart contracts on blockchains.

### BACKGROUND

A blockchain is distributed ledger where each entry is (cryptographically) linked to the previous entry. A Blockchain (BC) deployment consists of several servers running the BC software/stack. The use of a distributed Byzantine-fault-tolerant consensus ensures integrity, authenticity, and resilience of the blockchain and the data stored on it.

A smart contract is a computer protocol intended to digitally facilitate, verify, or enforce the negotiation or performance of predefined transactions, such as the execution of the terms of a contract. Smart contracts enable the performance of credible transactions without the need for third parties. Although the term “smart contract” implies the self-execution of a contract, the term “smart contract” is used more specifically in the sense of general purpose computation or any kind of computer program that takes place on a blockchain.

Because smart contracts are self-executing, there is a need to be able to automatically verify smart contracts that execute on blockchains.

### SUMMARY

Embodiments of methods, apparatuses and systems for automated verification of a smart contract on a blockchain are disclosed herein.

In some embodiments a method for automated verification of a smart contract on a blockchain includes translating operating properties of a smart contract annotated with contract specifications at a source code level into verification conditions in an intermediate verification language, discharging the verification conditions using an SMT solver, and reporting results of the discharged verification conditions. In some embodiments, the translating can include mapping statements of the smart contract to statements of the intermediate verification language and mapping expressions of the smart contract to expressions of the intermediate verification language. In some specific embodiments, the translating can include mapping state variables of the smart contract to global variables of the intermediate verification language and mapping functions of the smart contract to procedures of the intermediate verification language.

In some embodiments, an apparatus for automated verification of a smart contract on a blockchain includes a processor and a memory coupled to the processor. The memory of the processor includes stored therein at least one of programs or instructions executable by the processor to configure the apparatus to translate operating properties of a smart contract annotated with contract specifications at a source code level into verification conditions in an intermediate verification language, discharge the verification conditions using an SMT solver, and report results of the discharged verification conditions. In some embodiments, the translating can include mapping statements of the smart contract to statements of the intermediate verification language and mapping expressions of the smart contract to expressions of the intermediate verification language. In some specific embodiments, the translating can include mapping state variables of the smart contract to global variables of the intermediate verification language and mapping functions of the smart contract to procedures of the intermediate verification language.

In some embodiments, a system for automated verification of a smart contract on a blockchain includes a plurality of servers connected via a permissioned blockchain, a local network to provide a blockchain operating protocol for the plurality of servers, and an apparatus including a processor and a memory coupled to the processor. The memory of the processor includes stored therein at least one of programs or instructions executable by the processor to configure the apparatus to translate operating properties of a smart contract annotated with contract specifications at a source code level into verification conditions in an intermediate verification language, discharge the verification conditions using an SMT solver, and report results of the discharged verification conditions. In some embodiments, the translating can include mapping statements of the smart contract to statements of the intermediate verification language and mapping expressions of the smart contract to expressions of the intermediate verification language. In some specific embodiments, the translating can include mapping state variables of the smart contract to global variables of the intermediate verification language and mapping functions of the smart contract to procedures of the intermediate verification language.

Other and further embodiments of the present principles are described below.

### BRIEF DESCRIPTION OF THE DRAWINGS

Embodiments of the present principles, briefly summarized above and discussed in greater detail below, can be understood by reference to the illustrative embodiments of the principles depicted in the appended drawings. However, the appended drawings illustrate only typical embodiments of the present principles and are therefore not to be considered limiting of scope, for the present principles may admit to other equally effective embodiments.

FIG. 1 depicts a high level block diagram of a distributed computing environment in which an embodiment of the present principles can be applied in accordance with an embodiment of the present principles.

FIG. 2 depicts a Solidity contract for describing processes in accordance with an embodiment of the present principles.

FIG. 3a depicts a simple Solidity contract.

FIG. 3b depicts the Boogie translation of the Solidity contract of FIG. 3a in accordance with an embodiment of the present principles.

FIG. 4a depicts Ethereum and blockchain features in Solidity.

FIG. 4b depicts a representation of the various Ethereum and blockchain features translated in Boogie in accordance with an embodiment of the present principles.

FIG. 5 depicts a representative block diagram of an architecture of an operational embodiment of the present principles in accordance with one embodiment of the present principles.

FIG. 6 depicts a high level block diagram of one of the servers or the controller of FIG. 1 capable of performing the herein described functions and processes of the present principles in accordance with an embodiment of the present principles.

FIG. 7 depicts a flow diagram of a method 700 for automated verification of a smart contract on a blockchain in accordance with an embodiment of the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

In the following description, numerous specific details are set forth in order to provide a thorough understanding of exemplary embodiments or other examples described herein. However, these embodiments and examples may be practiced without the specific details. In other instances, well-known methods, procedures, components, and/or circuits have not been described in detail, so as not to obscure the following description. Further, the embodiments disclosed are for exemplary purposes only and other embodiments may be employed in lieu of, or in combination with, the embodiments disclosed. For example, although embodiments of the present principles are described with respect to specific programming and verification languages, embodiments of the present principles can be using other programming and verification languages in accordance with various embodiments of the present principles.

Embodiments in accordance with the present principles provide methods, apparatuses and systems for automated verification of a smart contract on a blockchain. In various embodiments in accordance with the present principles, the operating properties of a smart contract annotated with contract specifications are translated into verification conditions at a source code level in an intermediate verification language. The verification conditions can then be discharged using an SMT solver. In some embodiments, the operating conditions of the smart contract are translated by mapping statements of the smart contract to statements of the intermediate verification language and mapping expressions of the smart contract to expressions of the intermediate verification language. In some specific embodiments, the operating properties of the smart contract are translated by mapping state variables of the smart contract to global variables of the intermediate verification language and by mapping functions of the smart contract to procedures of the intermediate verification language. Results of the discharged verification conditions, such as successes and failures of the discharged verification conditions can be reported.

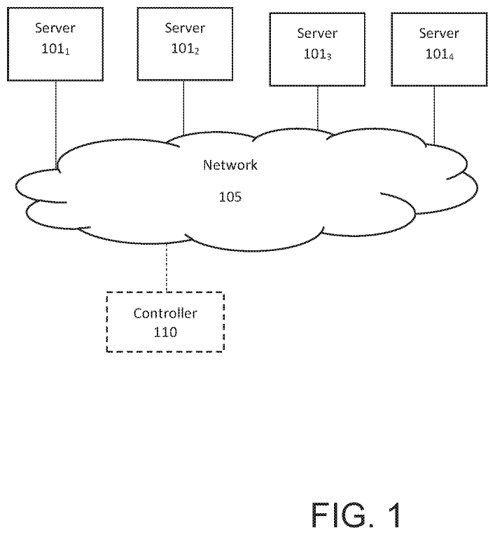

FIG. 1 depicts a high level block diagram of a distributed computing environment implementing a blockchain deployment in which an embodiment of the present principles can be applied. More specifically, the distributed computing environment 100 of FIG. 1 illustratively comprises a plurality of (illustratively four) servers 101₁-101₄ (collectively servers 101) running a blockchain software/stack and communicating via a local network 105. The distributed computing environment 100 of FIG. 1 further illustratively comprises an optional controller 110 for, in some embodiments, implementing the herein described processes and functionality of the present principles (described in greater detail below). Although in the embodiment of FIG. 1, the network 105 is depicted as a local network, in other embodiments in accordance with the present principles, In some embodiments in accordance with the present principles, the network 105 can comprise a local area network, a wide area network, a virtual private network, a wireless local network, a system area network, a passive optical network, an enterprise private network, an internet or any number of different computer systems connected by physical and/or wireless connections that enable computers and/or individuals to share information and resources.

In one embodiment in accordance with the present principles, an Ethereum computing platform is implemented in the distributed computing environment 100 of FIG. 1. Ethereum is a generic blockchain-based distributed computing platform. The servers 101 run the Ethereum Virtual Machine (EVM) and execute transactions and contracts compiled to EVM bytecode. The native currency of the Ethereum platform is called Ether. The Ethereum ledger is a storage layer for a database of accounts and data associated with those accounts, where each account is identified by its 160-bit address. Ethereum contracts are usually written in a high-level programming language, most notably Solidity, and the contracts are then compiled into EVM bytecode. A compiled contract is deployed to the blockchain using a special transaction that carries the contract code and calls the contract constructor to setup the initial contract state. At that point, the deployed contract is issued an address and stored on the ledger. From then on, the contract is publicly accessible and its code cannot be modified. In order to interact with a contract, a user (or another contract) needs to know the contract's public API, and can then call public functions by issuing a transaction with the contract's address as the recipient. The transaction additionally contains the function to be called along with possible arguments, and an execution fee called gas. Optionally, some value of Ether can also be transferred with transactions. The Ethereum servers 101 then execute the transaction by running the contract code in the context of the contract instance. During execution, each instruction costs some predefined amount of gas. If the contract overspends a gas limit, or there is a runtime error (e.g., an exception is thrown, or an assertion is triggered), the entire transaction is aborted and has no effect on the ledger (apart from charging a sender for the used gas).

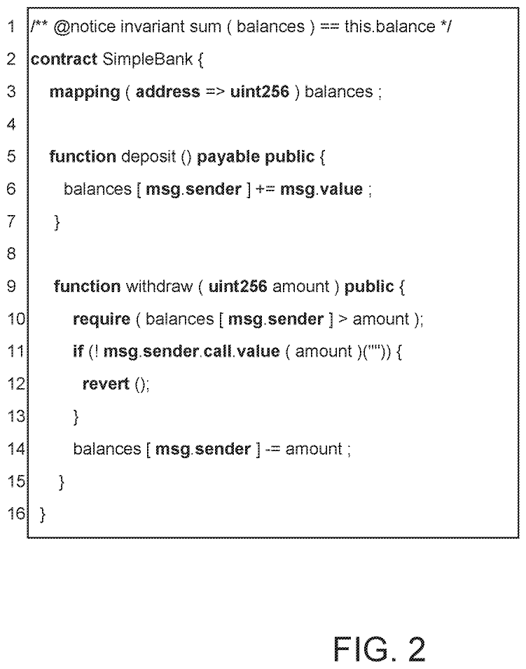

For the purposes of illustration, FIG. 2 depicts a Solidity contract, SimpleBank, in which users can deposit and withdraw Ether with the corresponding functions and in which the contract keeps track of user balances. As depicted in FIG. 2, the top level annotation in the Solidity contract, SimpleBank, states that the contract will ensure that the sum of individual balances is equal to the total balance in the bank. A smart contract can have state variables, which define the persistent data that the contract will store on the Ethereum blockchain. In the example of SimpleBank, the contract consists of a single variable balances, which is a mapping from addresses to 256-bit integers. Further Solidity types include value types, such as Booleans, signed and unsigned integers (of various bit-lengths), addresses, fixed-size arrays, enums, and reference types, to be used with arbitrary-size arrays and structures. Once deployed to the blockchain, an instance of SimpleBank will be assigned its address and since no constructor is provided, the data will be initialized to default values (in this case an empty mapping). Contracts can also define functions that can act on the state of the contract. A function can receive data as arguments, perform computation, manipulate the state variables and interact with other accounts. In addition to declared parameters, functions also receive a msg structure that contains the details of the transaction.

The example SimpleBank contract illustratively defines two public functions, deposit and withdraw. The deposit function is marked as public and payable, meaning that the function can be called by anyone and is allowed to receive Ether as part of the call. This function reads the amount of Ether received from msg.value and adds the amount to the balance of the caller, whose address is available in msg.sender. The withdraw function allows users to withdraw a part of their bank balance. The function first checks that the sender's balance in the bank is sufficient using a require statement. If the condition of require fails, the transaction is reverted with no effect. Otherwise the function sends the required amount of Ether funds by using a call on the caller address with no arguments (i.e., denoted by an empty string). The amount to be transferred is set with the value function. The recipient of the call can be another contract that can perform an arbitrary action on its own (within the gas limits) and can also fail (indicating the failure in the return value). If the call fails, the entire transaction is reverted with an explicit revert, otherwise the balance of the caller is decreased in the mapping as well.

In the example, SimpleBank, depicted in FIG. 2, a reentrancy vulnerability exists that can be exploited to steal funds from the bank. More specifically, in the SimpleBank contract of FIG. 2, as the control is transferred to the caller in line 11, before the caller's balance is deducted in line 14, the caller is able to make another call to withdraw to perform a double (or multiple) spending.

The inventors propose herein an automatic, precise and scalable approach for formal verification of smart contracts, such as Ethereum smart contracts that can identify failures and vulnerabilities of smart contracts, such as the SimpleBank contract illustrated in FIG. 2. In one embodiment in accordance with the present principles, a contract (e.g., a Solidity contract), annotated with contract specifications, is translated into an intermediate verification language, such as Boogie, and verification conditions are ultimately discharged by SMT solvers. That is in accordance with the present principles, the expected behavior of contracts can be defined using annotations within the contract code, including assertions, contract and loop invariants, and function pre- and post-conditions. Such annotations are essentially side-effect free expressions ensuring both expressiveness and ease of use.

In some embodiments in accordance with the present principles, a modular software verification approach (e.g., VCC, HAVOC, and ESC/Java) is applied to Solidity smart contracts. That is, in some embodiments in accordance with the present principles modular program verification is implemented for efficient reasoning of composite programs built up from smaller modules, such as classes, interfaces, objects and procedures. Modular verification usually includes a specification language and a program logic. The specification language enables formal specification of the modules with various kinds of annotations, including class and object invariants, loop invariants, and function pre- and post-conditions. A purpose of the programming logic is to check each module independently whether it satisfies its specification by assuming the related modules' specifications to hold.

Modular verification in the domain of smart contracts, however, brings domain-specific challenges, such as that the semantics of the Solidity language include Ethereum-specific constructs such as the blockchain state, transactions, and data-types not common in general programming languages. In general, such challenges are addressed by developing a general SMT-friendly encoding of Solidity into Boogie that is expressive enough to capture the properties of interest, and takes advantage of SMT solving to enable effective reasoning about those properties. Specific solutions to such challenges are described in detail below. Embodiments of the present principles enable the identification of non-trivial bugs in contracts. After the identified bugs are corrected, the correctness of the contracts can be verified using embodiments of the present principles.

Embodiments of the present principles work at the level of the source code which enables the extension of the specification language with domain-specific properties that are crucial for describing the contract functionality but otherwise not possible to express. For example, a large portion of Ethereum smart contracts manage balances of users with respect to some asset. It is often natural and desirable to express (as a contract-level invariant) that the amount of the individual assets should be equal to the total supply. One example is the contract invariant of SimpleBank in FIG. 2, which succinctly expresses the security of the bank and enables the identification of the reentrancy problem with the contract. The sum function over mappings cannot be expressed at the level of Solidity as the language doesn't allow iteration over maps. Similarly, the sum is also not expressible in first order logic. Therefore the inventors propose a domain-specific treatment that works for practical examples. That is, the specification language is extended with a sum over collections. Then, during the translation a shadow variable is introduced that denotes the sum and keeps track of it as the collection is changed. For example, whenever an item in the collection gets updated, the shadow variable is also updated. This way, if the programmer refers to the sum in an annotation, the shadow variable is used in place. This shadow sum is an abstraction of the precise sum that is strong enough to prove many of the properties of interest.

In some embodiments in accordance with the present principles, Solidity contracts can be translated into, for example, Boogie IVL or other derivative language such as Why3. For example in some embodiments in accordance with the present principles, a collection of contracts to be verified can be transformed into Boogie and the output is a single Boogie program including all of the contracts. It should be noted that, although Solidity allows a form of inheritance, the result of inheritance is always a single “flattened” contract. As the flattening and virtual-call disambiguation is done by the Solidity compiler, without a loss of generality, the contract is assumed to have no inheritance and the focus is becomes one of the case of a single contract. In such an embodiment, the basic idea of the translation is to simply map contract state variables to Boogie global variables and contract functions to Boogie procedures.

The Solidity language offers a variety of types, most of them common in programming languages, which are easily translated to Boogie types. In some embodiments, Booleans are simply mapped to the Boolean type of Boogie. Solidity integers can be either singed and unsigned and can be of different bitwidths (8, 16, 24, . . . , 256 bits). In contrast, Boogie has mathematical (unbounded, signed) integers. In one embodiment, a simple encoding includes mapping any Solidity integer to the mathematical integer of Boogie. This might lead to imprecise analysis, so a precise encoding is provided by relying on SMT bitvectors, and a pure arithmetic encoding that relies on modular arithmetic (described in greater detail below).

Addresses in Solidity are represented with 160-bit integers. However, as there is no arithmetic or comparison (beyond equality) allowed, in some embodiments in accordance with the present principles, the addresses are mapped to a predefined, un-interpreted address type. Solidity map types are modeled directly as SMT arrays. Boogie does not have a native array type so, in some embodiments, Solidity array types are translated to a pair of an integer length and an SMT array from integers to their element type. Contract reference types are simply represented by addresses. Type checking is already performed by the compiler so only compatible types can be passed around (e.g., as arguments).

In some embodiments, state variables of a Solidity contract are mapped to global variables in Boogie. However, multiple instances of a contract can be deployed to the blockchain at different addresses. Since aliasing is not possible, each state variable is modeled as a one-dimensional global mapping from contract addresses to their respective type (i.e., similar to treating the blockchain as a heap in a Burstall-Bornat model). Visibility specifiers (e.g., public, private) are enforced by the compiler so there is no need to treat them in any special way for translating.

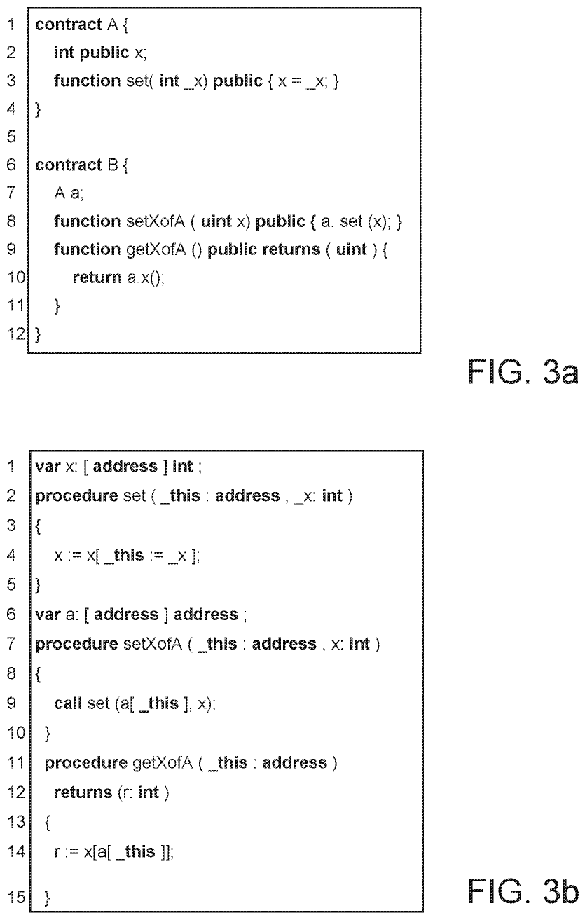

FIG. 3a depicts a simple Solidity contract and FIG. 3b depicts the Boogie translation, illustrating the representation of the blockchain data as a heap and the receiver parameter of functions. In FIG. 3a, the state variable x with type int at line 2 is transformed to the global variable x with type [address]int in line 1 of FIG. 3b.

In some embodiments in accordance with the present principles, a function in Solidity is translated to a procedure in Boogie with the same parameters and return value, and an additional implicit receiver parameter called _this, which identifies the address of the contract instance. As an example, consider the set function of the Solidity contract in FIG. 3a. Updating the variable x in the Boogie program becomes an update of the map x using the receiver parameter _this. Consider also the call a.set(x) in the Solidity function setXofA. In the Boogie program the address of the A instance corresponding to the current B instance is obtained using a[_this]. This address is then passed to the receiver parameter of the function set.

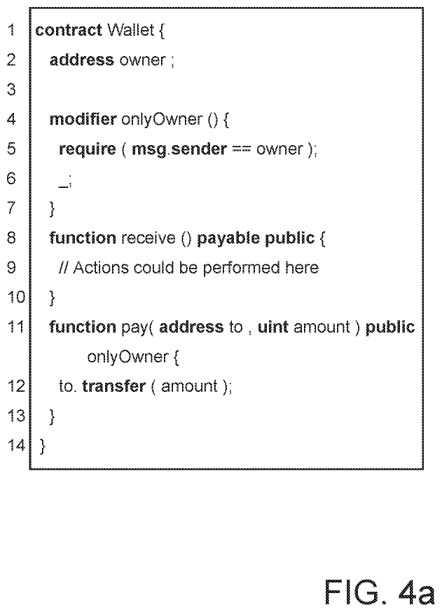

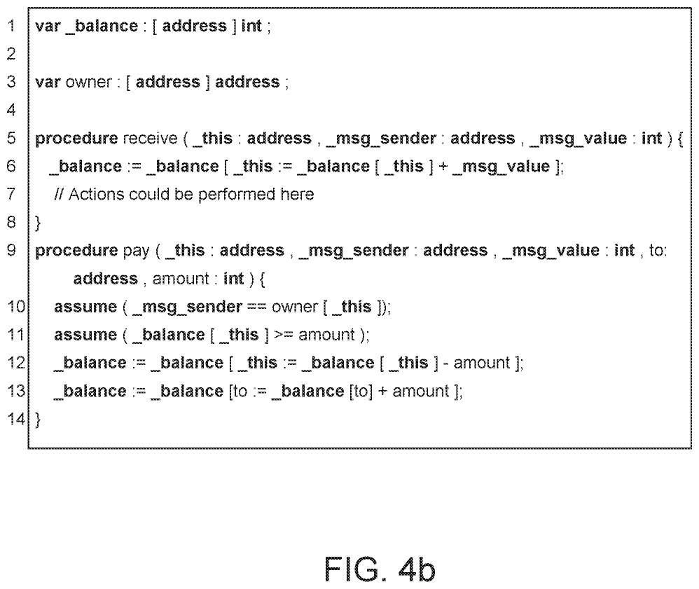

In some embodiments, functions can be associated with a visibility (e.g., public, private) and can be declared view (cannot write state) or pure (cannot read or write state). These restrictions are checked by the compiler so they do not need to be treated in a transformation. Additional user-defined function modifiers are a language feature of Solidity to alter or extend the behavior of functions. In practice, modifiers are commonly used to weave in extra checks and instructions to functions (similarly to aspect-oriented programming). For example, FIG. 4a depicts a simple wallet, which can receive Ether from anyone, but only an owner can make transfers. That is, FIG. 4a depicts various Ethereum and blockchain features in Solidity and FIG. 4b depicts a representation of the various Ethereum and blockchain features translated in Boogie. The pay function in FIG. 4a includes the modifier onlyOwner (defined in line 4), which performs an extra check before calling the actual function (denoted by the placeholder _). The transformation inlines statements of all modifiers of a function to obtain a single Boogie procedure (e.g., pay procedure in FIG. 4b).

In various embodiments in accordance with the present principles, most of the Solidity statements and expressions are directly mapped to a corresponding statement or expression in Boogie with the same semantics, including variable declarations, conditionals, while loops, calls, returns, indexing, unary/binary operations and literals. There are also some statements and expressions that require a simple transformation, such as mapping “for loops” to “while loops” or extracting nested calls and assignments within expressions to separate statements using fresh temporary variables. The availability of some arithmetic expressions depends on the expressiveness of the underlying domain (e.g., bitwise operations).

Solidity includes domain-specific functions and variables to query and manipulate Ethereum balances and transactions. Some examples can be seen in FIG. 4a with the corresponding Boogie translation in FIG. 4b. Each address is associated with its balance on the ledger, which can be queried using the .balance member of the address. Correspondingly, a translation keeps track of the balances in a global mapping from addresses to integers as depicted in line 1 of FIG. 4b. Solidity offers the msg.sender field within functions to access the caller address as depicted in line 5 of FIG. 4a. This is mapped to Boogie by adding an extra parameter _msg_sender of type address to each procedure. When a procedure calls another, the current receiver address (_this) is passed in as the sender argument.

Solidity functions marked with the payable keyword, as depicted line 8 of FIG. 4a, are capable of receiving Ether when called. The amount of Ether received can be queried from the msg.value field. In some embodiments, this is modeled in Boogie by including an extra parameter _msg_value and updating the global balances map at the beginning of the corresponding Boogie procedure as depicted in line 6 of FIG. 4b. When calling a payable function in Solidity, the amount of Ether to be transferred can be set with the special value function as depicted in line 11 of FIG. 2. In some embodiments, such value is translated into Boogie by reducing the balance of the caller before making the call and passing the value as the _msg_value argument.

The functions send and transfer are dedicated functions to transfer Ether between addresses. The subtle difference between the two is that if transfer fails, the failure is propagated, whereas send indicates it with its return value. In some embodiments, these functions are inlined by manipulating the global balances mapping directly. For example, the transfer in line 12 of FIG. 4a is mapped to lines 11-13 of FIG. 4b. The sender not having enough funds is an expected transaction failure, which in some embodiments can be modeled with an assumption. The function call can call a function by its name on any address and can also pass arbitrary data (provided as bytes). Since there can be an unknown code behind the called address, such cases can be treated as an external call that can perform arbitrary computation. In such instances, the contract-level invariants are checked before such calls.

More specifically, similar to object and class invariants, a contract invariant is a constraint over the state variables of the contract that expresses the consistency of the contract state. These constraints must hold at any point after the contract has been deployed and can be called. In order to ensure this, a contract invariant must hold after the contract constructor, after any public function, and before any call to external contracts. In some embodiments, a contract invariant can be any side-effect free Boolean expression having the same scope as the contract in question (e.g., state variables and this.balance can be referenced). Contract invariants are written with specific top-level annotations of the contracts code. During verification, each contract-level invariant can be checked as a post condition to the constructor, as pre- and post-condition to every public function, and as an assertion before every external call.

In order to be able to prove properties of contracts that include loops, loops can be annotated with invariants. Similarly to contract-level invariants, annotations are provided to express invariants over for or while loops. These annotations can access the contract state, variables and parameters of their enclosing function, and the loop counter. In general loop invariants can be complex and difficult to write by developers. However, due to the Ethereum execution fees, loops in Solidity contracts tend to be simple and to have a constant bound. For such loops, developers can specify invariants easily.

In smart contracts, solidity exceptions will undo all changes made to the global state by the current call (and all of its sub-calls) and flag an error to the caller. In such instances a distinction is made between expected and unexpected failures. Unexpected failures, such as assert is mapped to an assertion in Boogie, which is checked by the verifier. In contrast, expected failures, such as require, revert and throw are mapped to assumptions, making the verifier stop without reporting an error.

More specifically, functional correctness of Solidity contracts are targeted with respect to completed transactions and different types of failures. Ethereum transactions can either complete successfully or fail due to a runtime exception. For the purposes of verification two categories of transaction failures are distinguished. An expected failure is a failure due to an exception deliberately thrown to guard from the user. An unexpected failure is any other failure. Examples of expected failures can include exceptions thrown with the require statement (used commonly to check function arguments), manually thrown exceptions, and exceptions resulting from running out of gas. Unexpected failures are for example exceptions triggered by assert statements. A contract is considered to be correct if all contract transactions (public function calls) that do not fail due to an expected failure also do not fail due to an unexpected failure and satisfy the explicit contract specification. Note that, although it is common to distinguish between partial and total correctness of programs, in the context of Ethereum, the execution fee (gas) ensures termination, making the two concepts equivalent.

Solidity provides only a few error handling constructs (e.g., assert, require) for the programmer to specify expected behavior. Therefore, in various embodiments, various in-code annotations are used to specify contract properties. With the exception of domain-specific extensions, these annotations follow Solidity expressions syntax and typing, making it easy for developers to write and understand the specification.

As previously eluded to, integers in Solidity can be signed or unsigned and can be 8, 16, 24, . . . , 256 bits long. Operations over integers in typical contracts are mostly mathematical (addition, subtraction, etc.), but Solidity also supports bit-wise operations that are used in real-world contracts to a lesser extent. Depending on the complexity of operations, a contract is using, reasoning about integers of such large bit-widths can be challenging. By default, Boogie treats the integer type as unbounded mathematical integers. This representation allows scalable reasoning with SMT solvers, especially in the case where the constraints are linear, with much progress being made in recent years on also solving the non-linear constraints. As such, in some embodiments, all Solidity integer types can be encoded to unbounded integers. A caveat of this encoding is that such coding does not support bit-precise operations, and that the types and operations are not sound for representing the semantics of Solidity integers (e.g., operations don't overflow). Therefore, verification results should be treated with an extreme caution in this case as the verification results can result in both false alarms and unsound proofs. For example, unsigned integers are guaranteed to be non-negative in Solidity, but the mathematical integers can be possibly negative, causing a false alarm. However, if the contract does not include any bit-wise operations, and the programmer is confident that that no arithmetic operations goes out of range (e.g., by manually checking ranges or using a library), this encoding can provide good results.

In order to support exact semantics for Solidity arithmetic, in some embodiments, an encoding that uses the SMT theory of bitvectors can be used to model the integer types and operations over them. Such encoding enables the translation of almost all Solidity operations to SMT in a fairly straightforward manner.

To strike a balance between precision and scalability, the inventors developed an encoding of integers scheme that models Solidity integers as unbounded integers in Boogie, but adds additional constraints to model the precise semantics, the allowed value ranges and the wraparound semantics. In some embodiments, to track ranges, a type condition (TC) is developed to each integer variable denoting its exact range. Every operation over integers variables can then be performed by first assuming the TCs and then performing the corresponding operation in arithmetic modulo the TC range (with additional constraints to adjust the results for special cases and signed integers). This approach is further sound across all arithmetic expressions since, if the inputs are assumed in the correct range, the results of the operations produce further values in the correct ranges. An advantage of this approach is that the scalability of reasoning is less dependent on the bit-width, with efficient reasoning also available for, for example, nonlinear operations over 256-bit integers.

With respect to smart contracts, neither the Ethereum Virtual Machine nor Solidity performs any checking of the results of arithmetic operations by default. Due to the wraparound semantics of integers, unexpected overflows and underflows can occur undetected. In some embodiments in accordance with the present principles, to remedy such a deficiency, the inventors propose implementing a formal overflow detection in the context of Solidity that provides a scalable solution to overflow detection with minimal false reports. For example, overflows can be detected by checking the results of every operation for a potential overflow. This can be accomplished, for example, by checking if the output of the operation is the same as if computed over unbounded integers. However, reporting every such overflow would result in an overwhelming number of false alarms. For example, it is common practice for Solidity developers to perform arithmetic operations first, and then check for overflows manually after the fact. This practice of overflow detection is used in almost all deployed contracts on the Ethereum blockchain and is part of Solidity best practices. Reporting such potential overflows would be a nuisance to the programmer who has already put effort into guarding against it. To reduce the number of false overflow reports, in some embodiments in accordance with the present principles, whenever an arithmetic computation is performed, the overflow condition that captures whether the overflow has occurred (i.e., if the result of the computation is different from the result over unbounded integers) is computed. However, instead of immediately checking this condition, the results can be accumulated in a dedicated Boolean overflow-detection variable. Overflow is then checked at the end of every basic block with an assertion. This “delayed checking” gives space to a developer to perform manual checking for the overflow (in which case the assertion will not trigger) and will avoid the false alarms.

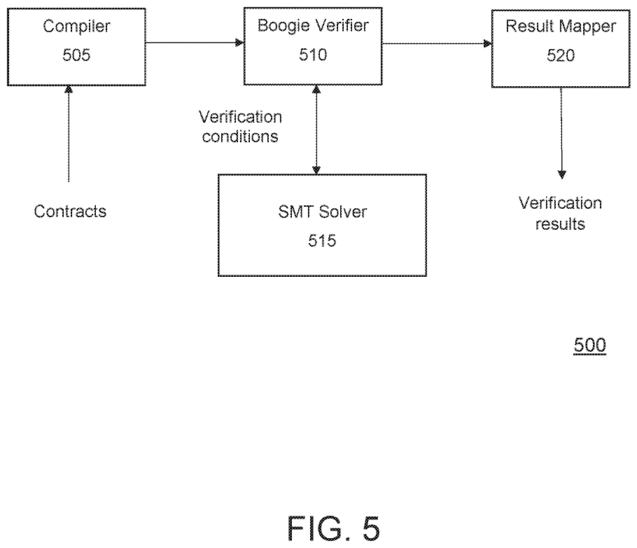

FIG. 5 depicts a representative block diagram of an architecture 500 of an operational embodiment of the present principles in accordance with one embodiment of the present principles. In the illustrative embodiment of FIG. 5, the Solidity compiler (version 0.4.25) was implemented using a Boogie verifier and several SMT solvers. The architecture 500 of the verification process of the embodiment of FIG. 5 comprises a single script that acts as the Solidity compiler, but also performs the verification. In the embodiment of the architecture 500 of FIG. 5, the compiler 505 receives and parses the contracts, resolves names, references and types, and builds an abstract syntax tree (AST). The information from the compiler 505 is computed to the Boogie verifier 510. At the boogie verifier 510, an application in accordance with the present principles (e.g. a middleware) then refers to the AST and produces a Boogie representation (e.g., program) based on a translation in accordance with an embodiment of the present principles and specifically as described above. The resultant Boogie program is annotated with traceability information to be able to map back the results. Boogie transforms the program into verification conditions and communicates the verification conditions to the SMT solver 515. The SMT solver 515 discharges the verification conditions using SMT solvers.

The Boogie verifier 510 reports results of the discharged verification conditions such as violated pre and post-conditions and failing assertions in the Boogie program. Illustratively in FIG. 5, the result mapper 520 maps these errors back to the Solidity files using the traceability information can report a list of errors/failures corresponding to the original contracts (e.g., line numbers, function names, etc.). In some embodiments, the specification (on the source level) corresponding to the failure is reported to enable the identification of which invariant fails. In accordance with embodiments of the present principles, the errors/failures can be reported to, for example a user/programmer, using, for example, at least one of a command line, an annotation inside a code of any of the programs associated with implementing the present principles (e.g., the Boogie verifier 510, the compiler 505, the middleware, the SMT solver 515 or any other program), a GUI (not shown) or a display of one of the servers 101 or the optional controller 110 or any other display means available.

In various embodiments, the herein described processes of the present principles can be executed in a processor associated with at least one of servers 101 of the distributed computing environment 100 of FIG. 1 or a processor associated with the local network 105 of the distributed computing environment 100 of FIG. 1. In other embodiments, the herein described processes of the present principles can be executed in a processor associated with the optional controller 110 of FIG. 1. In yet other embodiments in accordance with the present principles the herein described processes of the present principles can be executed in a cloud processor.

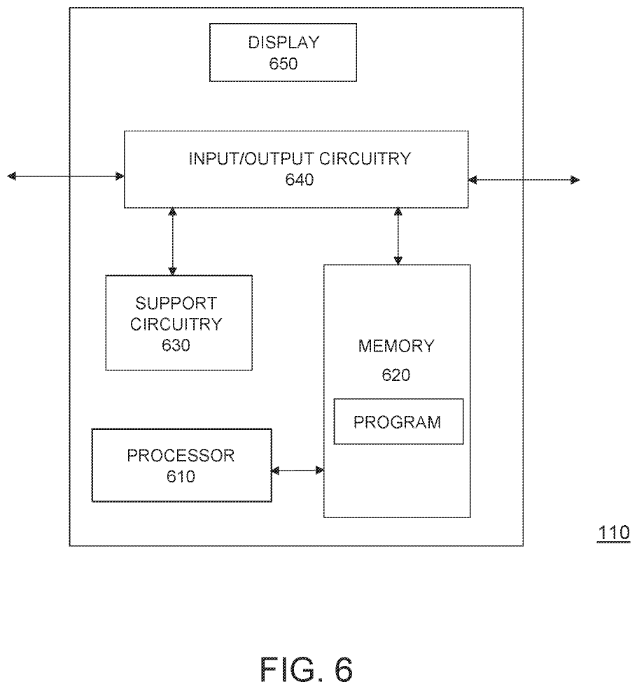

FIG. 6 depicts a high level block diagram of one of the servers 101 or the controller 110 capable of performing the herein described functions and processes of the present principles in accordance with an embodiment. The serves 101 or the controller 110 of FIG. 9 illustratively comprises a processor 610, which can include one or more central processing units (CPU), as well as a memory 620 for storing control programs, configuration information, backup data and the like. The processor 610 cooperates with support circuitry 630 such as power supplies, clock circuits, cache memory and the like as well as circuits that assist in executing the software routines/programs of the present principles stored in the memory 620. As such, some of the process steps discussed herein as software processes may be implemented within hardware, for example, as circuitry that cooperates with the processor 610 to perform various steps. The server 101 or controller 110 also contains an input-output circuitry and interface 640 that forms an interface between the various functional elements communicating with the server 101 or controller 110. For example, in some embodiments the input-output circuitry and interface 640 can include or be connected to an optional display 650, a keyboard and/or other user input (not shown). The input-output circuitry and interface 640 can be implemented as a user interface for interaction with the server 101 or controller 110.

The server 101 or controller 110 can communicate with other computing devices based on various computer communication protocols such as Wi-Fi, Bluetooth™ (and/or other standards for exchanging data over short distances includes protocols using short-wavelength radio transmissions), USB, Ethernet, cellular, an ultrasonic local area communication protocol, etc. The server 101 or controller 110 can further include a web browser.

Although the server 101 or controller 110 of FIG. 6 is depicted as a general purpose computer, the server 101 or controller 110 is programmed to perform various specialized control functions in accordance with the present principles and embodiments can be implemented in hardware, for example, as an application specified integrated circuit (ASIC). As such, the process steps described herein are intended to be broadly interpreted as being equivalently performed by software, hardware, or a combination thereof.

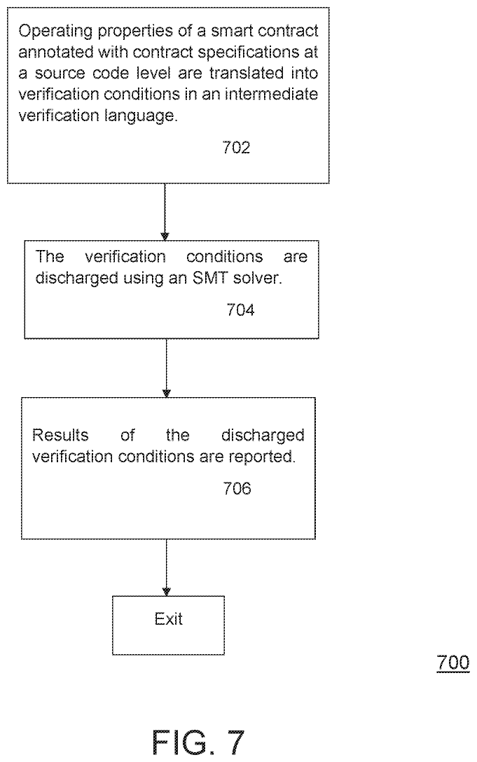

FIG. 7 depicts a flow diagram of a method 700 for automated verification of a smart contract on a blockchain in accordance with an embodiment of the present principles. The method 700 begins at 702 during which operating properties of a smart contract annotated with contract specifications at a source code level are translated into verification conditions in an intermediate verification language. The method 700 can proceed to 704.

At 704, the verification conditions are discharged using an SMT solver. The method 700 can proceed to 706.

At 706, results of the discharged verification conditions are reported, for example in one embodiment, to a programmer. The method 700 can be exited.

In some embodiments, a non-transitory computer-readable storage device includes stored thereon a plurality of instructions, the plurality of instructions including instructions which, when executed by a processor, cause the processor to perform a method in accordance with embodiments of the present principles. For example, in one embodiment in accordance with the present principles, a non-transitory computer-readable storage device includes stored thereon a plurality of instructions, the plurality of instructions including instructions which, when executed by a processor, cause the processor to translate operating properties of a smart contract annotated with contract specifications into verification conditions at a source code level in an intermediate verification language, and discharge the verification conditions using an SMT solver. In various embodiments in accordance with the present principles, the processor can be further configured report results of the discharged verification conditions. In some embodiments such results can include failures/errors in the discharged verification conditions.

While the foregoing is directed to embodiments of the present principles, other and further embodiments may be devised without departing from the basic scope thereof. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

In the foregoing description, numerous specific details, examples, and scenarios are set forth in order to provide a more thorough understanding of the present principles. It will be appreciated, however, that embodiments of the principles can be practiced without such specific details. Further, such examples and scenarios are provided for illustration, and are not intended to limit the teachings in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Modules, data structures, blocks, and the like are referred to as such for case of discussion, and are not intended to imply that any specific implementation details are required. For example, any of the described modules and/or data structures may be combined or divided into sub-modules, sub-processes or other units of computer code or data as may be required by a particular design or implementation of the servers 101 and/or the optional controller 110.

1. A method for automated verification of a smart contract on a blockchain, comprising:
translating operating properties of a smart contract on the blockchain annotated with contract specifications at a source code level into verification conditions in an intermediate verification language;
discharging the verification conditions using an SMT solver; and
reporting results of the discharged verification conditions.

2. The method of claim 1, wherein the translating comprises, mapping statements of the smart contract to statements of the intermediate verification language and mapping expressions of the smart contract to expressions of the intermediate verification language.

3. The method of claim 1, wherein for a domain specific operating property of the smart contract that is not directly expressible using a language used to annotate the contract specifications or first order logic, an expression is formulated for the domain specific operating property using the language used to annotate the contract specification that is expressive enough to capture at least one property of interest of the domain specific operating property.

4. The method of claim 3, wherein the formulated expression is defined as an extension of the contract specifications.

5. The method of claim 1, wherein the operating properties of the smart contract are defined in the contract specifications.

6. The method of claim 1, wherein the intermediate verification language comprises at least one of a Boogie program and a derivative program such as Why3.

7. The method of claim 1, wherein the translating includes translating explicit specifications of contract-level properties of the smart contract, and implicit specifications of semantics of the smart contract.

8. The method of claim 1, wherein the smart contract comprises a Solidity contract and a language in which the smart contract specifications are annotated comprises a Solidity language.

9. The method of claim 1, wherein the operating properties of the smart contract are annotated in the contract specifications in a modular structure and the verification conditions of the smart contract are discharged modularly.

10. The method of claim 9, wherein the modular structure comprises at least one of class and object invariants, loop invariants, and function pre-conditions and post-conditions.

11. The method of claim 1, wherein results of the discharged verification conditions comprise at least one of violated pre-conditions and post-conditions, violated loop invariants, and failing assertions in the intermediate verification language.

12. The method of claim 1, wherein the results are mapped to the smart contract.

13. An apparatus for automated verification of a smart contract on a blockchain, comprising:
a processor; and
a memory coupled to the processor, the memory having stored therein at least one of programs or instructions executable by the processor to configure the apparatus to:
translate operating properties of a smart contract on a blockchain annotated with contract specifications at a source code level into verification conditions in an intermediate verification language;
discharge the verification conditions using an SMT solver; and
report results of the discharged verification conditions.

14. The apparatus of claim 13, wherein for a domain specific operating property of the smart contract that is not directly expressible using a language used to annotate the contract specifications or first order logic, the apparatus is configured to formulate an expression for the domain specific operating property using the language used to annotate the contract specification that is expressive enough to capture at least one property of interest of the domain specific operating property.

15. The apparatus of claim 13, wherein the apparatus is configured to annotate the operating properties of the smart contract in the contract specifications in a modular structure and the verification conditions of the smart contract are discharged modularly.

16. The apparatus of claim 13, wherein the apparatus is configured to map state variables of the smart contract to global variables of the intermediate verification language and map functions of the smart contract to procedures of the intermediate verification language

17. A system for automated verification of a smart contract on a blockchain, comprising:
a plurality of servers connected via a permissioned blockchain;
a local network to provide a blockchain operating protocol for the plurality of servers; and
an apparatus comprising a processor and a memory coupled to the processor, the memory having stored therein at least one of programs or instructions executable by the processor to configure the apparatus to:
translate operating properties of a smart contract on a blockchain annotated with contract specifications at a source code level into verification conditions in an intermediate verification language;
discharge the verification conditions using an SMT solver; and
report results of the discharged verification conditions.

18. The system of claim 17, wherein the processor of the apparatus comprises a processor of a cloud server.

19. The system of claim 17, wherein the apparatus comprises a controller.

20. The system of claim 17, wherein the processor of the apparatus comprises a processor associated with at least one of at least one of the plurality of servers, a processor associated with the local network or a processor associated with a local controller.
